(19) United States
(12) Patent Application Publication
(10) Pub. No.: US 2003/0149981 A1
(43) Pub. Date: Aug. 7, 2003

(54) System and method for generating customized EPG data and EPG application programs

(76) Inventors: Paul Finster, New York, NY (US); David Ruderman, Brooklyn, NY (US); Patrice Ribero, Nice (FR)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/066,230

(22) Filed: Jan. 31, 2002

(51) Int. Cl. G06F 3/00; H04N 5/445; G06F 13/00

(52) U.S. Cl. 725/46; 725/47

(57) ABSTRACT

A system and method for generating and displaying customized electronic programming (EPG) data is described. One embodiment includes a method for generating a customized program listing for a set top box (STB). This method includes the steps of receiving a user preference for operating an EPG; retrieving programming information; sorting the retrieved programming information according to the user preference; formatting the sorted program information according to the user preference; and providing the formatted program information to the STB.

### FIELD OF THE INVENTION

The present invention relates generally to electronic program guides (EPGs). In particular, but not by way of limitation, the present invention relates to customized EPG data and application programs.

### BACKGROUND OF THE INVENTION

As the number of available TV channels increases, the need for more sophisticated program guides also increases. Although newspaper listings and magazines were adequate when TV viewers received a few dozen channels, they are inadequate when viewers receive hundreds of channels as they do with satellite TV and digital cable. To help viewers better manage their program listings, EPGs were developed. Early EPGs provided programming information in the vertical blanking interval (VBI) of an analog TV signal. A set-top box (STB) connected to the viewer's TV would extract the program information from the VBI, parse it, and display it for the viewer. In this type of system, the STB generally received more information than the viewer required and, thus, the STB was forced to sort the information to present only the relevant data. Obviously, these early systems had significant drawbacks such as high bandwidth usage and the need for proprietary code in the STBs to interpret the received programming information. In fact, the need for proprietary code in each STB meant that early EPGs were extremely difficult to deploy across varied types of STBs.

With the development of digital cable and satellite TV systems, STBs were significantly redesigned. For example, the digitally-enabled STBs generally include a middleware layer on top of a PC-type hardware layer, and depending upon the manufacture and model of the STB, the middleware layer can include browser-type functionality and/or an interpreted language engine such as a JavaScript engine. By incorporating browser-type functionality and/or an interpreted language engine into an STB, EPG applications can be more easily transported from one type of STB to another.

Although EPGs have been developed for digitally-enabled STBs, these EPGs have failed to fully take advantage of the new technology. For example, present EPGs do not adequately utilize the two-way interactive capabilities of digital cable and similar content delivery systems. Accordingly, a system and method are needed to take advantage of new technology and to overcome problems with the existing technology.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for generating and/or delivering preference-based programming information and custom EPG application programs to viewers. For example, one system in accordance with the present invention can dynamically build customized applications (which may include data) that are delivered to client STBs for execution. The application delivered to the STB can be personalized for the client to reflect the client's explicit and implicit preferences. In one embodiment of the present invention, an STB is connected to a viewer's TV and to a network. When activated, the STB receives TV programming and related programming information through the network. Assuming that the network connected to the STB allows for a two-way exchange of data, the STB can provide a viewer's EPG preference data to an EPG provider and can receive programming information that is customized according to that preference data. For example, the viewer could request the program information to be displayed in a grid format or a frame-based list format. In fact, because of the two-way interactive nature of the STB, the viewer could select almost any customization of the EPG. Alternatively, the viewer could provide preference data to the EPG provider through a website.

After the viewer's EPG configuration preferences have been identified, one embodiment of the present invention generates a customized application program for delivery to and execution on the STB. This customized application program can include the modules necessary both to render the EPG as preferred by the viewer and to interact with the viewer in a certain way. For example, if the viewer indicated that parental control was preferred, the custom-generated application program could include the modules for checking program ratings and blocking programs with certain ratings absent a password. Alternatively, the viewer could choose to have a parental control module that blocks programming information related to any program with an “R” rating. If the viewer did not want any parental control, the application program running at the STB would not need to include any parental-control modules.

In other embodiments, the present invention can customize the programming information, e.g., the listing information, delivered to the viewer according to the viewer's selected preferences. For example, if the viewer selected a “NO SPORTS” option, all programming information related to sports could be omitted from the programming information provided to the viewer. Alternatively, if the viewer selected to be notified about all John Ford movies being shown, the customized programming information could include a list of all John Ford movies being shown in the next two weeks. When the viewer wants to view this list, the STB (via associated middleware) retrieves the data from local storage or a network device (local or external) and displays it according to the viewer's preferences. Because only relevant, needed programming information is transmitted from the EPG provider to the viewer's STB, network traffic is decreased and overall network performance is increased. The programming information can even be carried out-of-band such as in DOCIS frequencies. Moreover, the STB is not forced to parse, sort or filter the programming information to comply with the viewer's preferences. The programming information comes from the EPG provider in a “ready-to-use format.”

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a system constructed according to the principles of the present invention;

FIG. 2 is a block diagram of the STB shown in FIG. 1;

FIG. 3 is a flowchart of one method for generating and providing preference-based programming information to an STB;

FIG. 4 is a flowchart of one method of managing preference-based programming information received at an STB;

FIG. 5 is a flowchart of one method for generating a customized application program for viewing programming information; and

FIG. 6 is a flowchart of another method for generating a customized application program for viewing programming information.

### DETAILED DESCRIPTION

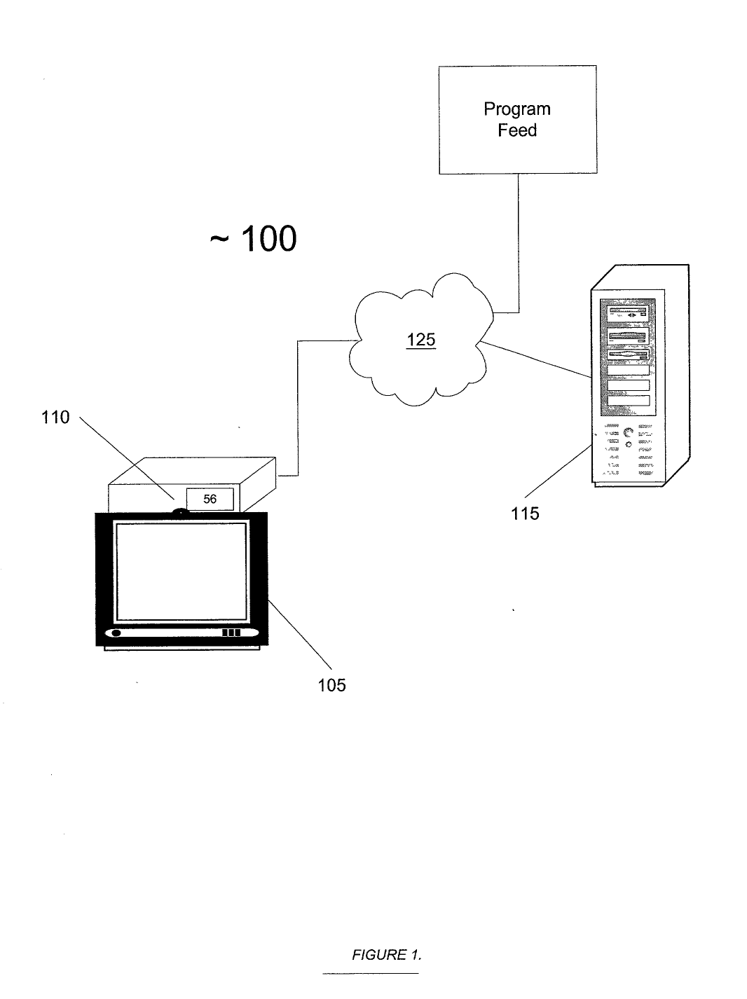

Referring now to the drawings, where like or similar elements are designated with identical reference numerals throughout the several views, and referring first to FIG. 1, it illustrates a system 100 constructed in accordance with the principles of the present invention. In this embodiment, a TV 105, video monitor or other display is connected to an STB 110 that is equipped with two-way interactive capabilities. In other words, the STB 110 can receive data from external sources such as an EPG server 115 and a program feed 120 and can transmit data back to those external sources.

In this embodiment, the STB 110 is configured to receive programming from a program feed 120 through the network 125. Similarly, the STB 110 is configured to receive EPG data, e.g., programming information and application programs, from an EPG server 115. Notably, the STB 110 can be configured to receive both programming and EPG data in a digital format. Thus, the STB 110 can be configured to manipulate the data by, for example, compression and decompression techniques.

Because the STB 110 is equipped with two-way interactive capabilities, the STB 110 can advantageously provide information to the program feed 120 and to the EPG server 115. For example, the STB 110 can provide the program feed 120 with information regarding Pay Per View requests. Similarly, the STB 110 can provide the EPG server 115 with information regarding a viewer's EPG preferences. These STB features are discussed in more detail with regard to the subsequent figures.

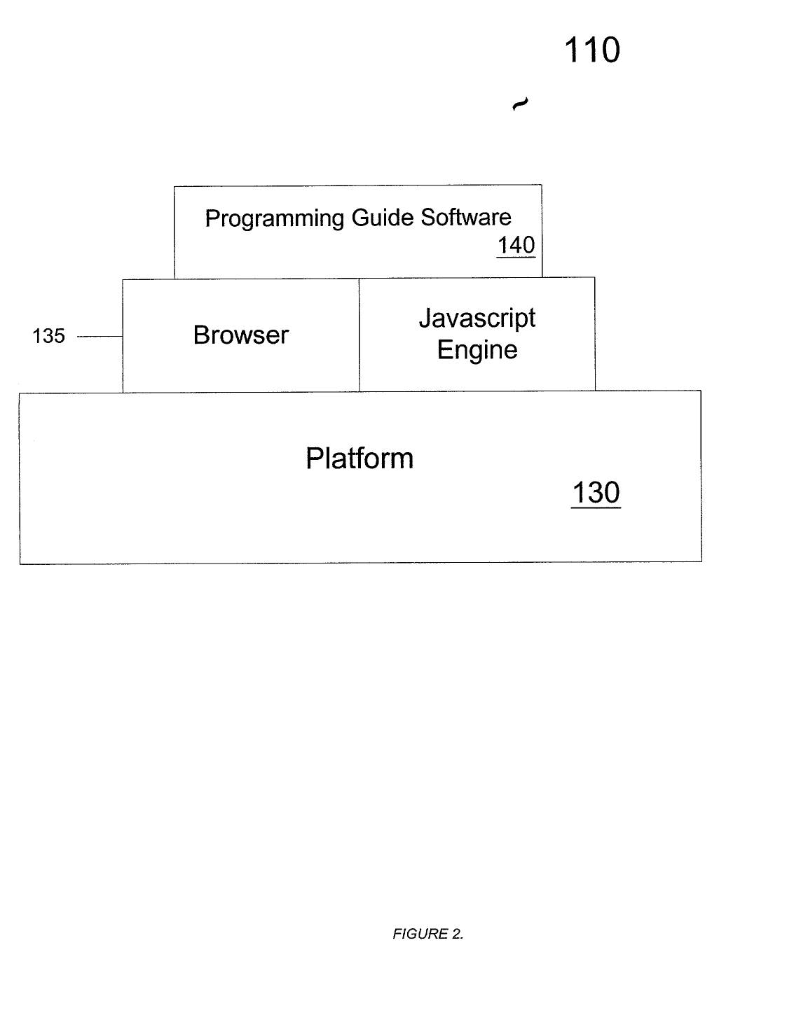

Referring now to FIG. 2, it illustrates a block diagram of an STB 110 as shown in FIG. 1. This STB 110 includes a platform layer 130, than includes at least a processor and memory; a middleware layer 135 that includes a browser and/or an interpreted language engine such as a JavaScript engine or virtual machine; and programming guide software 140. The configuration of STBs varies widely because there are several different manufacturers. Basic digital STBs, for example, are manufactured by several companies including: Pace, Samsung, Zenith, Philips, Motorola and Scientific-Atlanta. Similarly, the middleware configuration varies because companies such as Liberate, OpenTV and Microsoft offer their own products with their own functions. Embodiments of the present invention, however, can incorporate most any STB 110. In fact, programming guide software 140 constructed according to the principles of the present invention, can be adapted to operate on the many different platforms 130 and middleware 135 that are currently available or that will be available in the future.

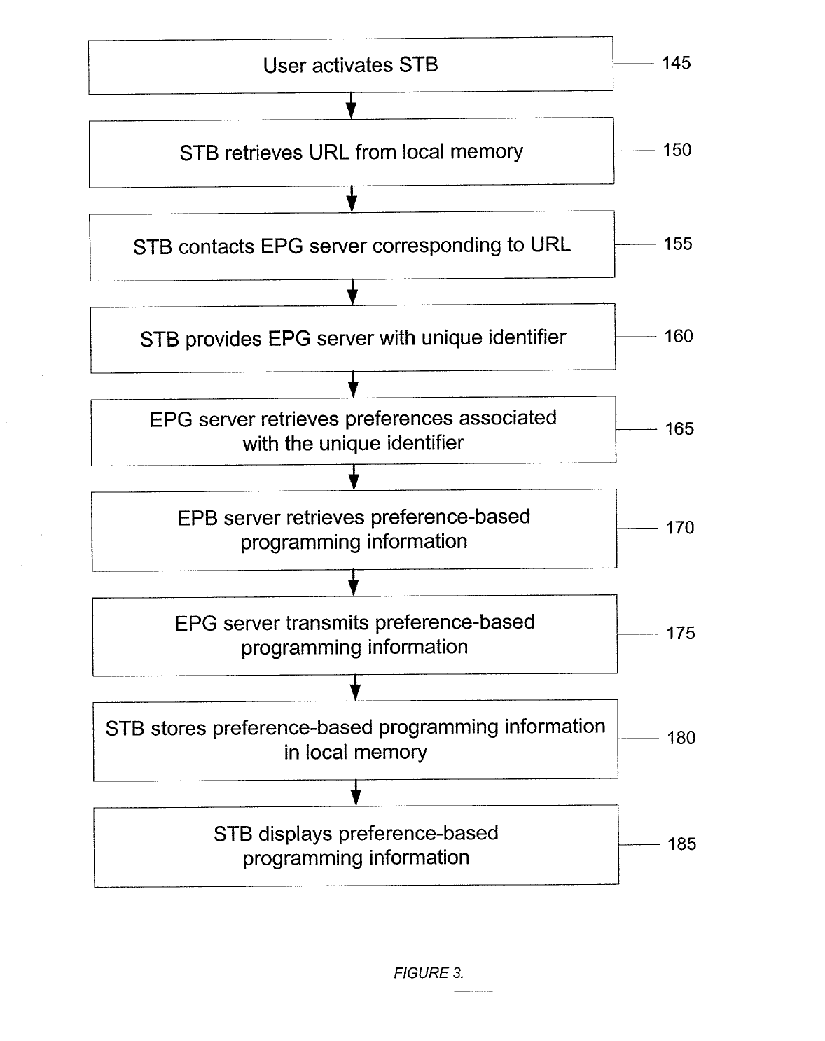

Referring now to FIG. 3, it is a flowchart of one method for providing preference-based, i.e., customized, preference-based programming information to an STB 110. In this embodiment, a viewer initially activates an STB (step 145). For example, the viewer could activate the STB 110 for the first time after receiving cable service or turn on the STB 110 after a period of non-use. The STB 110, in response to being activated, retrieves an external contact address, such as a URL, from local memory and attempts to contact that external address for instructions (steps 150 and 155). Assuming that the contact address is associated with an EPG server 115, the EPG server 115 can establish the identity of the STB 110 by reading a unique identifier from the STB 110 or receiving the unique identifier from the STB (step 160).

Once the EPG server 115 identifies the STB 110 with which it is communicating, the EPG server 115 determines the EPG preferences associated with the STB—or in reality the viewer (step 165). For example, the EPG server 115 may determine that the viewer does not want to see any sporting information or that the viewer's STB 110 does not have enough local memory to store detailed program listings. In other embodiments, the STB 110 could initially transmit to the EPG server 115 a preference code indicating which preferences the viewer wants.

The EPG server 115 may also determine the time of the last download to the STB 110 and the new amount of data needed to keep the STB 110 updated. For example, if the STB 110 should locally store two future weeks of programming information and the last download to the STB 110 was two days ago, then the STB 110 needs only two additional days of data rather than the full two weeks.

After the EPG server 115 has determined the viewer's preferences and, if required, the amount of needed programming information, the EPG server 115 retrieves or generates the relevant programming information and any related data (step 170). The EPG server 115 can retrieve the relevant information by sorting a larger database of all programming information or by joining tables that contain certain pieces of the information. The EPG server 115, for example, could dynamically assemble the customized programming information or could retrieve a previously generated block of programming information corresponding to the viewer's preferences. In either embodiment, however, once the relevant programming information is identified, the EPG server 115 can assemble the data and transmit it to the STB 110 (step 175). By assembling the information at the EPG server 115, the STB 110 is not necessarily required to parse the programming information, and thus, does not need to know a substantial amount about the received programming information beyond how to display it. In one embodiment, however, the STB 110 could sort some or all of the programming information received from the EPG server 115.

An example of a JavaScript data structure that the EPG server 115 could produce to run on the STB is shown below. This type of data structure and application program can be delivered to the STB 110 and rendered by the software thereon.

//DEFINING OBJECTS “CLASSES”
function Channel(name, displaynumber, id, startprogramindex, programs)
{

| | |
|---|---|
| this.name | = name; |
| this.displaynumber | = displaynumber; |
| this.id | = id; |

| | |
|---|---|
| this.startprogramindex | = startprogramindex; |

| //startprogramindex[hour (0-23)] = 3 | | |
|---|---|---|
| this.programs | = programs; | //Program[] |

}
//A Program contains all the information for the grid (title, duration . . . )
//and also for the light progdesc (episode, description, genre . . . )

function Program(pid, title, duration, starttime_min, episode, description, starttime, endtime, genreid, rerun, cc, star_rating, mpaa_rating, year, live, udatetime)

{

| //Properties | |
|---|---|
| this.pid | = pid; |

| | | |
|---|---|---|
| this.title | = title; | |
| this.duration | = duration; | //(in minutes) |
| this.starttime_min | = starttime_min; | //(in minutes) |
| this.episode | = episode; | |
| this.description | = description; | |
| this.starttime | = starttime; | |
| this.endtime | = endtime; | |
| this.genreid | = genreid; | |
| this.rerun | = rerun; | |
| this.cc | = cc; | |

| this.star_rating= star_rating; | |
|---|---|
| this.mpaa_rating | = mpaa_rating; |
| this.year | = year; |
| this.live | = live; |
| this.udatetime | = udatetime; |

}
//A Genre contains the genre's name and id
function Genre(name, id)
{

this.name = name;
this.id = id;

}

Referring to the above code, function “channel” is declared in the second line with the attributes: name of the channel (“name”); the channel to which a user would tune his television to see the named channel (“displaynumber”); a unique identifier for the particular channel for that user (e.g., distinguishing that user's channel 13 from another user's in a neighboring market) (“id”); an array of pointers that indexes the start times of programs (“startprogramindex”); and an array of chronologically ordered programs on a particular channel (“programs”).

Still referring to the above code, the function “program” returns a Program Object that is a data structure including the fields under the heading “Properties.” In particular, “pid” is a unique program identifier. “Startime_min” is a duration indicator used in formatting the display of the program information. “Udatetime” is universal date time start time, year, month, date, time, which is helpful in making time zone adjustments in calculating local start times. Finally, “starttime” is the local start time.

“Genre” is a function that returns a genre object that takes a genre name and associates it with a numeric genre identifier. This creates a mapping between each numeric genre identifier and textual genre name. This field and other fields in the data structure can be altered according to fields requested by the user.

Referring again to FIG. 3, once the STB 110 receives the programming information, the STB 110 can store that data locally in, for example, a high-speed memory (step 180). Upon request by the viewer, the STB 110 can retrieve the relevant portions of the programming information and display them either in a standardized fashion or a customized fashion (step 185). Notably, the programming information can be displayed by the middleware browser or JavaScript engine.

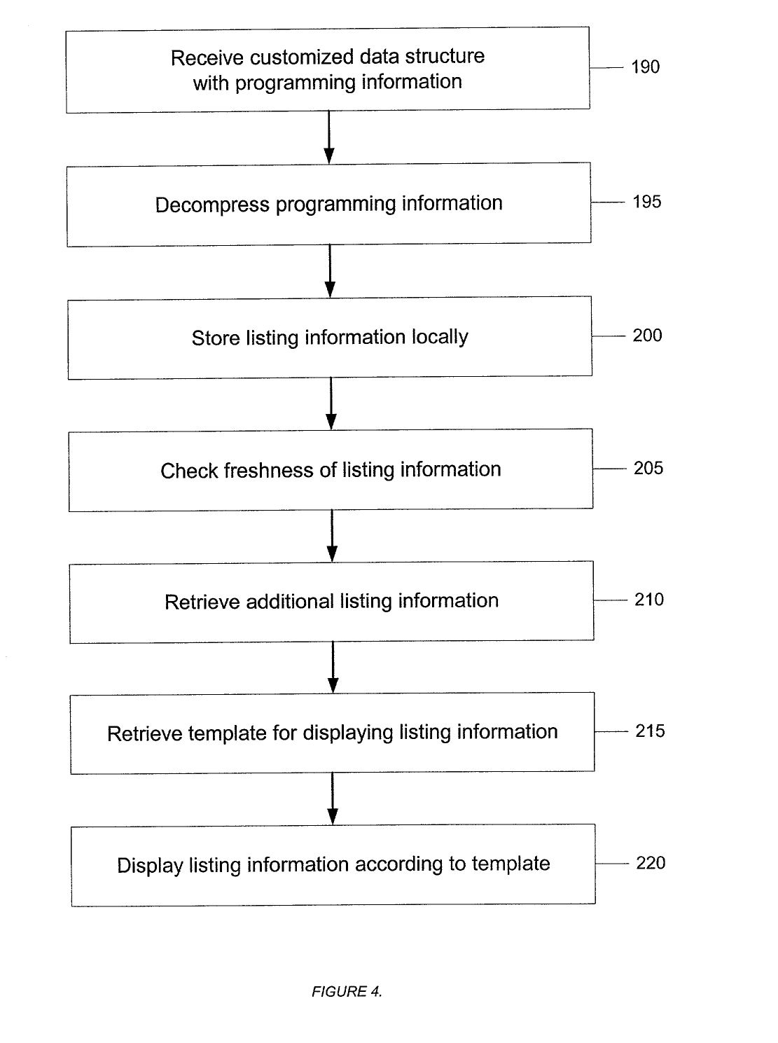

Referring now to FIG. 4, it is a flowchart of one method of managing preference-based programming information received at an STB. In this embodiment, the STB 110 receives a customized data structure containing the programming information preferred by the viewer 190. Depending upon the implementation, the STB 110 could receive the customized data structure in response to a request generated by the STB 110 or in response to a push by the EPG server 115. Moreover, the STB 110 could receive the data structure according to any of the various communication protocols—including emailed files. If needed, the STB 110 could even decompress the programming information prior to storing it locally (steps 195 and 200).

Occasionally, the STB 110 may check the freshness of the programming information and, if needed, request supplemental information from the EPG server 115 (steps 205 and 210). For example, the data structure may include a field that indicates the date range for which the included programming information—or portions thereof—is valid. If a portion of the data is no longer valid, that portion may be discarded and a request for new programming information generated. The EPG server 115 could supply this new programming information in a new customized data structure.

In certain embodiments, the data structure received by the STB 110 may also include a template for rendering the included programming information. The programming guide software 140 running on the STB 110 could extract the template and render the programming information accordingly (steps 215 and 220). In other embodiments, however, the template information could be separately transferred to the STB 110 such that the programming guide software 140 would retrieve the template from local memory to render the programming information. In yet other embodiments, the template would be omitted and the programming guide software 140—and/or the middleware—would be responsible for rendering the programming information. In either embodiment, however, the programming guide software 140 could use the browser properties of the STB's middleware to render the programming information. If the data structure in which the programming information is contained is a JavaScript data structure, then a JavaScript engine could help render the programming information. Of course, other programming languages could also be used.

The following is an example of a data structure in accordance with one embodiment the present invention. This data structure contains programming information for five channels for two hours. It advantageously creates a new grid of an array of channels. “Progs” is a new array of entertainment program information.

//OBJECT DECLARATION

| | | |
|---|---|---|
| • | var grid = new Array( ); | //Channel[]: a grid is an array of |
| | Channels | |

| | | |
|---|---|---|
| • | var chan; | //temp Channel |

| | | |
|---|---|---|
| • | var progs = new Array( ); | //temp Program[] |
| • | var startindex = new Array( ); | //temp int[] |

| | |
|---|---|
| • | progs = new Array( ); |
| • | startindex = new Array( ); |
| • | progs[0] = new Program(“SH0263440000”,“Pay-Per-View |
| | Previews”,240,1628034,“”, |
| | “”,“2:00PM”,“6:00PM”,36,“N”,“N”,“”,“”,“”,“”,“200012141400”); |
| • | progs[1] = new Program(“SH0263440000”,“Pay-Per-View |
| | Previews”,240,16280580,“”, |
| | “6:00PM”,“10:00PM”,36,“N”,“N”,“”,“”,“”,“”,“200012141800”); |
| • | startindex[0] = 0; |
| • | startindex[1] = 1; |
| • | chan = new Channel(“PPVP”,1,14782,startindex, progs); |
| • | grid[0] = chan; |
| • | progs = new Array( ); |
| • | startindex = new Array( ); |
| • | progs[0] = new Program(“SH3255540000”,“News 2 at |
| | 5”,60,16280520,“”, “”,“5:00PM”, |
| | “6:00PM”,34,“N”,“Y”,“”,“”,“”,“”,“200012141700”); |
| • | progs[1] = new Program(“SH3255550000”,“News 2 at |
| | 6”,30,16280580,“”,“”,“6:00PM”, |
| | “6:30PM”,34,“N”,“Y”,“”,“”,“”,“”,“200012141800”); |
| • | progs[2] = new Program(“SH0008320000”,“CBS |
| | News”,30,16280610,“”,“Breaking |
| | news.”,“6:30PM”,“7:00PM”,34,“N”,“Y”,“”,“”,“”,“”,“200012141830”); |
| • | startindex[0] = 0; |
| • | startindex[1] = 1; |
| • | chan = new Channel(“WCBS”,2,11331,startindex, progs); |
| • | grid[1] = chan; |
| • | progs = new Array( ); |
| • | startindex = new Array( ); |
| • | progs[0] = new Program(“SH2332750000”,“Hardcore |
| | Football”,30,16280520,“”,“In-depth look at |
| | football.”,“5:00PM”,“5:30PM”,36,“N”,“N”,“”,“”,“”,“Tape”, |
| | “200012141700”); |
| • | progs[1] =new Program(“SH0388830000”,“Thoroughbred |
| | Action”,30,16280550,“”,“”, |
| | “5:30PM”,“6:00PM”,36,“N”,“N”,“”,“”,“”,“Tape”,“200012141730”); |
| • | progs[2] = new Program(“SH2472970000”,“The Last |
| | Word”,30,16280580,“”,“Interviews with newsmakers from the world |
| | of sports.”,“6:00PM”,“6:30PM”,44,“N”,“N”,“”,“”,“”, |
| | “Tape”,“200012141800”); |
| • | progs[3] = new Program(“SH3945560000”,“Football |
| | Today”,30,16280610,“”,“”, |
| | “6:30PM”,“7:00PM”,34,“N”,“N”,“”,“”,“”,“Live”,“200012141830”); |
| • | startindex[0] = 0; |
| • | startindex[1] = 2; |
| • | chan = new Channel(“FSNY”,3,11105,startindex, progs); |
| • | grid[2] = chan; |
| • | progs = new Array( ); |
| • | startindex = new Array( ); |
| • | progs[0] =new Program(“SH3233410000”,“Live at |
| | Five”,60,16280520,“”,“”,“5:00PM”, |
| | “6:00PM”,34,“N”,“N”,“”,“”,“”,“”,“200012141700”); |
| • | progs[1] = new Program(“SH3233390000”,“News Channel |
| | 4”,30,16280580,“”,“”, |
| | “6:00PM”,“6:30PM”,34,“N”,“N”,“”,“”,“”,“”,“200012141800”); |
| • | progs[2] = new Program(“SH0030610000”,“NBC |
| | News”,30,16280610,“”,“Breaking |
| | news.”,“6:30PM”,“7:00PM”,34,“N”,“Y”,“”,“”,“”,“”,“200012141830”); |
| • | startindex[0] =0; |
| • | startindex[1] =1; |
| • | chan = new Channel(“WNBC”,4,11705,startindex, progs); |
| • | grid[3] = chan; |
| • | progs = new Array( ); |
| • | startindex = new Array( ); |
| • | progs[0] = new Program(“EP0021200024”,“Home |
| | Improvement”,30,16280520,“Yule Better Watch Out”,“Tim tries to |
| | outdo a neighbor's holiday |
| | decorations.”,“5:00PM”,“5:30PM”,20,“N”,“Y”,“”,“”,“”,“”,“200012141 |
| | 700”); |
| • | progs[1] = new Program(“EP1638170027”,“3rd Rock From the |
| | Sun”,30,16280550,“Fourth and Dick”,“The aliens catch football fever |
| | on Homecoming |
| | Weekend.”,“5:30PM”,“6:00PM”,40,“N”,“Y”,“”,“”,“”,“”,“20001214173 |
| | 0”); |
| • | progs[2] = new Program(“EP1528700013”,“The Drew Carey |
| | Show”,30,16280580,“Isomers Have Distinct |
| | Characteristics”,“Employee strike during the holidays forces Drew to |
| | clerk.”,“6:00PM”,“6:30PM”,20,“N”,“Y”,“”,“”,“”,“”,“200012141800”); |
| • | progs[3] = new Program(“SH0875910000”,“The |
| | Nanny”,30,16280610,“”,“”,“6:30PM”, |
| | “7:00PM”,20,“N”,“Y”,“”,“”,“”,“”,“200012141830”); |
| • | startindex[0] = 0; |
| • | startindex[1] = 2; |
| • | chan = new Channel(“WNYW”,5,11746,startindex, progs); |
| • | grid[4] = chan; |

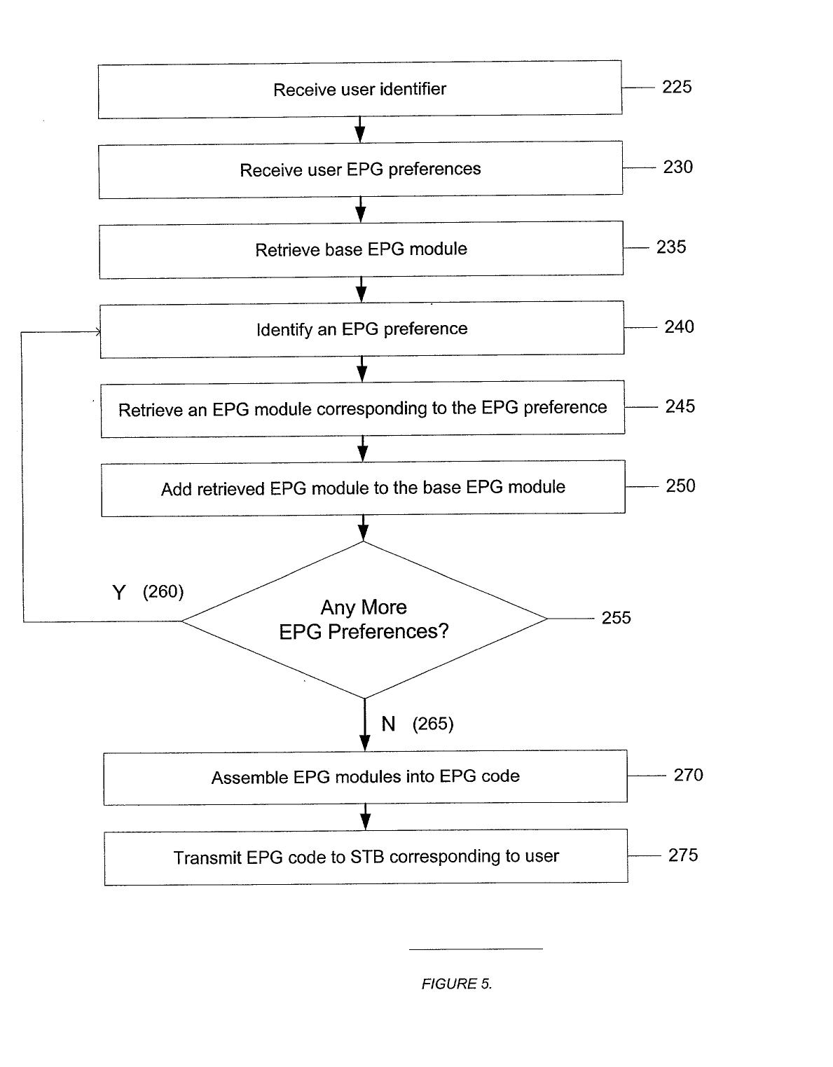

Referring now to FIG. 5, it is a flowchart of one method for generating a customized application program for rendering programming information according to the viewer's preferences. In this embodiment, the EPG server 115 receives an identifier for a viewer or an STB (step 225). Using that identifier, the EPG server 115 can either retrieve the viewer's preferences from local storage or receive the viewer's preferences directly from the STB (step 230).

After identifying the viewer's preferences, the EPG server 115 can generate an application program customized for the viewer. This application program can render the programming information according to the viewer's preferences and can provide the viewer with requested functionality. To generate the customized application program, the EPG server 115 initially retrieves a base EPG module (step 235). This module generally includes the basic functionality needed to render the programming information. Next, the EPG server 115 identifies a preference selected by the viewer, retrieves an EPG module corresponding to that preference, and adds that module to the base EPG module (steps 240, 245 and 250). For example, if the viewer has indicated “Parental Control” as a preference, then the EPG server 115 could retrieve a Parental Control module and add it to the base EPG module.

Next, the EPG server 115 can determine whether any more viewer preferences should be considered in generating the customized application program (step 255). If more preferences should be considered then branch Y (step 260) is followed and the above-described process is repeated. If all of the preferences have been considered, however, branch N (step 265) is followed and the EPG modules are assembled into an application program (step 270). This application program can then be provided to the STB 110 for local execution (step 275).

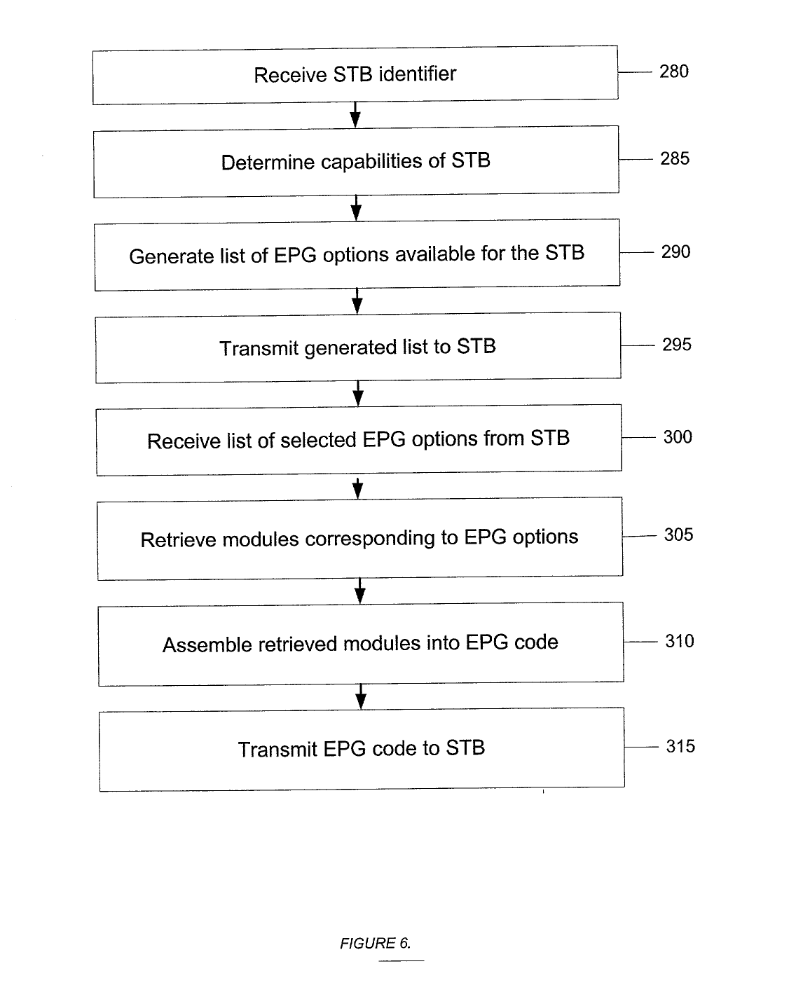

Referring now to FIG. 6, it is a flowchart of another method for generating a customized application program for viewing listing information. In this embodiment, the EPG initially receives an STB 110 identifier and possibly corresponding hardware characteristics such as processor speed and memory configuration (steps 280 and 285). Alternatively, the EPG server 115 could use the STB's identifier to look up the device's characteristics.

Once the EPG server 115 is aware of the STB's characteristics, the EPG server 115 can determine which options/preferences are available to the STB 110 and provide a corresponding list to the STB 110 and the viewer (steps 290 and 295). Using the list of available preferences, the viewer can select the desired ones. For example, the viewer could fill in an interactive form displayed on his TV by the STB 110. After the viewer has selected the desired preferences, that data is transmitted back to the EPG server 115 (step 300). The EPG server 115 can then retrieve EPG modules corresponding to the selected preferences, assemble those modules into an application program, and provide the application program to the STB (steps 305, 310 and 315).

An exemplary pseudo-code representation of one embodiment of the customization and generation abilities of the application program is shown below.

If (receive viewer request for new software from client) then

{
receive viewer_id
viewer_profile(viewer_id, display_parameters,

navigation_parameters, viewer_hardware)

generate_source_code(display_parameters, navigation_parameters,

viewer_hardware, generated_software)

send generated_software to client
}

In conclusion, the present invention provides, among other things, a system and method for generating and displaying customized EPG data. Those skilled in the art can readily recognize that numerous variations and substitutions may be made in the invention, its use and its configuration to achieve substantially the same results as achieved by the embodiments described herein. For example, the embodiments of the present invention can be implemented in any Virtual Machine architecture that provides a display engine and an execution engine. Accordingly, there is no intention to limit the invention to the disclosed exemplary forms. Many variations, modifications and alternative constructions fall within the scope and spirit of the disclosed invention as expressed in the claims.

What is claimed is:

1. A method for operating a set top box (STB), the method comprising:
providing a plurality of electronic program guide (EPG) preferences to an EPG provider;
receiving at the STB an EPG application program, wherein the EPG application program is configured according to at least one of the plurality of EPG preferences provided to the EPG provider;
storing the EPG application program in a memory associated with the STB;
receiving at the STB a programming information data structure, wherein the programming information data structure includes program listing information and wherein the programming information data structure is configured according to at least one of the plurality of EPG preferences; and
rendering at least a portion of the program listing information using the EPG application program.

2. The method of claim 1, further comprising:
providing a unique identifier from the STB to the EPG provider.

3. The method of claim 1, further comprising:
providing an STB characteristic to the EPG provider, wherein the received EPG application program is customized according to the provided STB characteristic.

4. The method of claim 3, wherein the STB characteristic comprises:
STB memory information.

5. The method of claim 3, wherein the STB characteristic comprises:
an STB manufacturer identifier.

6. The method of claim 1, wherein rendering at least a portion of the listing information comprises:
extracting a template from the programming information data structure; and
populating the template with at least a portion of the listing information.

7. The method of claim 1, wherein providing a plurality of EPG preferences comprises:
extracting a contact address from memory local to the STB, wherein the contact address is associated with an EPG provider; and
providing the unique identifier to the contact address.

8. The method of claim 1, wherein the received EPG application program comprises JavaScript code.

9. The method of claim 1, wherein the programming information data structure comprises a JavaScript data structure.

10. The method of claim 1, wherein the programming information data structure comprises freshness information, the method further comprising:
determining whether the freshness information indicates that additional listing information should be retrieved from the EPG provider.

11. A set top box (STB) comprising:
a processor; and
a memory device connected to the processor, the memory device comprising:
an electronic program guide (EPG) application program, wherein the EPG application program is configured according to a first EPG preference provided from the STB to an EPG provider; and
a program listing data item configured to be processed by the EPG application program, wherein the program listing data item comprises listing information and is configured according to a second EPG preference.

12. An electronic programming guide (EPG) system comprising:
a processor;
a memory connected to the processor; and
a plurality of instructions stored on the memory, the plurality of instructions configured to be executable by the processor to:
generate an EPG application program, wherein the EPG application program is configured according to a plurality of EPG preferences selected at a set top box (STB);
provide the EPG application program to the STB;
generate a programming information data structure, wherein the programming information data structure includes program listing information and wherein the programming information data structure is configured according to the plurality of the EPG preferences; and
provide the programming information data structure to the STB.

13. A method for dynamically generating a customized electronic program guide (EPG) program, the method comprising:
receiving an identifier for a set top box (STB);
determining a characteristic for the STB;
generating a list of EPG options available to the STB, wherein the list is generated according to the determined characteristic for the STB;
providing the list of EPG options to the STB;
receiving a plurality of selected EPG modules from the STB;
retrieving a plurality of EPG program options corresponding to the selected EPG options;
assembling the retrieved plurality of EPG program modules to form the customized EPG program; and
providing the customized EPG program to the STB.

14. The method of claim 13, wherein determining a characteristic for the STB comprises:
determining one of the hardware configuration and the device manufacturer.

15. The method of claim 13, wherein determining a characteristic for the STB comprises:
retrieving the characteristic from the STB.

16. The method of claim 13, wherein one of the plurality of EPG program modules comprises:
a parental control module.

17. The method of claim 13, wherein one of the plurality of EPG program modules comprises:
a frame viewing module.

18. The method of claim 13, wherein one of the plurality of EPG modules comprises:
instructions to cause a browser in the STB to display frames.

19. A method for dynamically generating a customized EPG program, the method comprising:
receiving EPG preference data;
retrieving program modules corresponding to the received EPG preference data;
assembling the retrieved program modules into an EPG program; and
providing the assembled EPG program to a viewer.

20. A method for generating a customized program listing for a set top box (STB), the method comprising:
receiving from an STB a user preference for operating an electronic program guide (EPG);
retrieving programming information;
sorting the retrieved programming information according to the user preference;
formatting the sorted program information according to the user preference; and
providing the formatted program information to the STB.

21. The method of claim 20, further comprising:
generating a template corresponding to the user preference; and
providing the template to the STB.

22. The method of claim 20, wherein providing the template to the STB comprises:
providing the template to the STB generally simultaneously with providing the formatted program information.

23. The method of claim 20, wherein formatting comprises:
arranging sorted program information into an interpreted-language data structure.

24. The method of claim 20, wherein sorting comprises:
generating a plurality of lists of program information, wherein at least one of the plurality of lists corresponds to the user preference.
